(19) United States
(12) Patent Application Publication
(10) Pub. No.: US 2007/0002705 A1
(43) Pub. Date: Jan. 4, 2007

(54) WRITE POWER CALIBRATING APPARATUS AND RELATED METHOD THEREOF

(76) Inventors: Kuo-Ting Hsin, Hsin-Chu Hsien (TW); Hong-Ching Chen, Kao-Hsiung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/160,654

(22) Filed: Jul. 4, 2005

(51) Int. Cl. G11B 7/12

(52) U.S. Cl. 369/47.53

(57) ABSTRACT

A write power calibrating method and related apparatus for determining an optimum write power used for recording data onto a digital versatile disc is disclosed. The write power calibrating method includes recording a plurality of first data sets onto the digital versatile disc by utilizing a plurality of different write powers respectively; executing an parity code decoding procedure on a plurality of second data sets read from the digital versatile disc to determine a plurality of byte error numbers detected by utilizing a parity code of each of the second data sets, the second data sets corresponding to the first data sets written onto the digital versatile disc; and determining the optimum write power according to the byte error numbers of the second data sets.

### BACKGROUND

The present invention relates to a laser controlling apparatus and a related method, and more particularly, to a write power calibrating apparatus and a related method thereof utilized to determine the optimum write power of the laser.

In usually, a digital versatile disc (DVD) recording system comprises a DVD drive and a DVD recordable disc. The DVD drive has a pick-up head, which emits a laser beam to heat the recording layer for recording data on the DVD recordable disc. As well known, different recording layers of the DVD recordable discs have different properties. For example, when the same laser beam (i.e., the same laser power) illuminates different DVD recordable discs, different levels of heating occur. As a result, when a DVD recordable disc is manufactured, a desired write power for this disc is pre-recorded in a lead-in area of the disc to serve as a reference during a recording session. Additionally, the DVD recordable disc produced by various manufacturers support an Optimum Power Control (OPC) procedure. The OPC procedure is applied for determining an optimum write power in order to ensure accuracy of the recording results.

Details of the related art method for performing the OPC procedures can be found in any optical disc specification. According to the U.S. Pat. No. 5,841,747, and 6,031,803, a related art write power calibrating apparatus for determining the optimum write power is disclosed. Firstly, the related art write power calibrating apparatus records a plurality of preliminary data sets in a memory unit. Secondly, the related art write power calibrating apparatus records the preliminary data sets onto the optical disc by utilizing a plurality of different write powers. Thirdly, the related art write power calibrating apparatus reads the preliminary data sets recorded onto the digital versatile disc, and stores the read result into the memory unit to serve as a plurality of reproduced data sets. Fourthly, the related art write power calibrating apparatus utilizes a comparison circuit to compare the preliminary data sets with the reproduced data sets to determine a byte error number of each reproduced data set. Please noted that the reproduced data set have not been decoded yet. Finally, the related art write power calibrating apparatus determines the optimum write power according to a write power corresponding to the minimum byte error number of the reproduced data sets.

However, if a defect exists in the region for recording the data sets, a series of byte errors occurs. Referring to FIG. 1, which is a profile associated with the byte error numbers and the corresponding write powers. As shown in FIG. 1, there is a “spike” caused by the defect. Therefore, the determined byte error numbers may be disturbed, and the generated optimum write power may be faulty. For solving the problem, the size of the preliminary data sets utilized related art method must be much greater than the region of a common defect to alleviate the influence of the defect. As a result, the computation of the related art method increases accordingly.

According to the U.S. Pat. No. 20041 36303, a related art optical disc apparatus for verifying the generated optimum write power of a digital versatile disc (DVD) is disclosed. The related art optical disc apparatus verifies the generated optimum write power according to the numbers of the detected PI errors of different data sets. Referring to FIG. 2, which is a schematic diagram of an Error Correction Code (ECC) block 10 applied in the DVD. The ECC block 10 includes 182*208 bytes Bᵢⱼ, where i and j denote the address of a byte. The ECC block 10 is divided into a data part 12 including 172*192 bytes, a Parity Inner (PI) code part 14 including 10*208 bytes, and a Parity Outer (PO) code part 16 including 16*172 bytes. Each row of the ECC block 10 comprises 172-byte data and 10-byte PI code utilized for detecting and correcting the error of the 172-byte data. Each column of the ECC block 10 comprises 192-byte data and 16-byte PO code utilized for detecting and correcting the error of the 192-byte data. A PI error is detected when five byte errors are detected in a row of an ECC block. In the same manner, a PO error is detected when eight byte errors are detected in a column of an ECC block. The PI error is rare if the byte error rate is smaller than 1*10⁻¹(5/182). Since the byte error rate is under 1*10⁻³ in practice, the detected PI errors cannot be utilized to determine a precise value of the optimum write power. As a result, the PI errors are utilized for verifying the generated optimum write power of a digital versatile disc according to the related art.

Additionally, a related art write power calibrating apparatus for determining the optimum write power of a compact disc is disclosed in the U.S. Pat. No. 6,557,126. Similar to the U.S. Pat. No. 20041 36303, the related art write power calibrating apparatus determines the byte error number corresponding to different write powers by executing a decoding procedure. However, owing to the properties of the encoding algorism of the compact disc, the size of each data set must be greater than a frame (i.e. 32 symbols).

In summary, the related arts are complicated and needs extra memory units and comparing units to generate the byte error numbers then determine the optimum write power according to the byte error numbers. As a result, a simple and precise method for obtaining the optimum write power is needed.

### SUMMARY

It is therefore one of the objectives of the claimed invention to provide a write power calibrating apparatus and method for determining the optimum write power according to the parity code recorded onto the digital versatile disc (DVD).

According to the claimed invention, a write power calibrating method for determining an optimum write power used for recording data onto a DVD is disclosed. The write power calibrating method comprises: recording a plurality of first data sets onto the DVD by utilizing a plurality of different write powers respectively; executing an parity code decoding procedure on a plurality of second data sets read from the DVD to detect a plurality of byte error numbers of the second data sets, the second data sets corresponding to the first data sets written onto the DVD and each of second data sets comprising a parity code; and determining the optimum write power according to the byte error numbers detected from the decoding parity code of the second data sets.

According to the claimed invention, a write power calibrating apparatus for determining an optimum write power used for recording data onto a DVD is disclosed. The write power calibrating apparatus comprises: a step power generator for generating a plurality of write powers used for driving a laser to record a plurality of first data sets onto the DVD according to the plurality of write powers respectively; an parity code decoding module for detecting a plurality of byte error numbers of a plurality of second data sets, the second data sets corresponding to the first data sets written onto the DVD and each of second data sets comprising a parity code; and an optimum power generating module for generating the optimum write power according to the byte error numbers detected from the decoding parity code of the second data sets.

The write power calibrating apparatus and the related method utilize the parity code decoding procedure to detect the byte error numbers of the data sets. The size of the data sets is smaller than the size of the data sets utilized by the related art due to the characteristic of the parity code decoding procedure. As a result, the optimum write power is generated with fewer system resources according to the present invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a profile associated with the byte error numbers and the corresponding write powers.

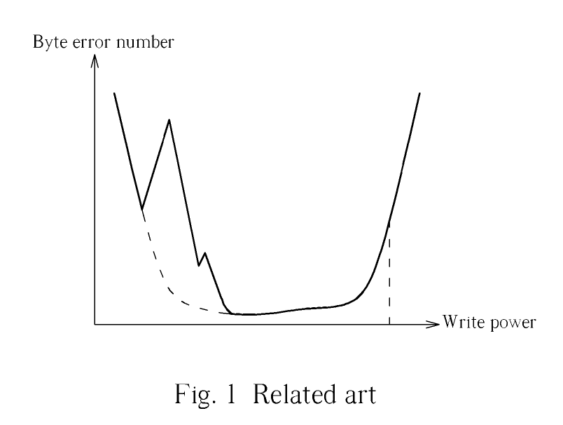

FIG. 2 is a schematic diagram of an ECC block applied in the DVD.

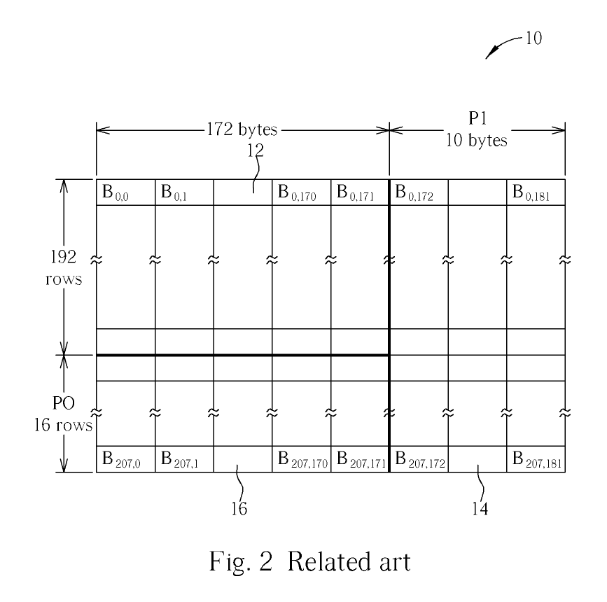

FIG. 3 is a flow chart of the write power calibrating method applied to a DVD recording device according to an embodiment of the present invention.

FIG. 4 is a schematic diagram of a profile associated with the byte error numbers and the corresponding write powers according to the present embodiment.

FIG. 5 is a functional block diagram of a write power calibrating apparatus applied in a digital versatile disc drive according to an embodiment of the present invention.

### DETAILED DESCRIPTION

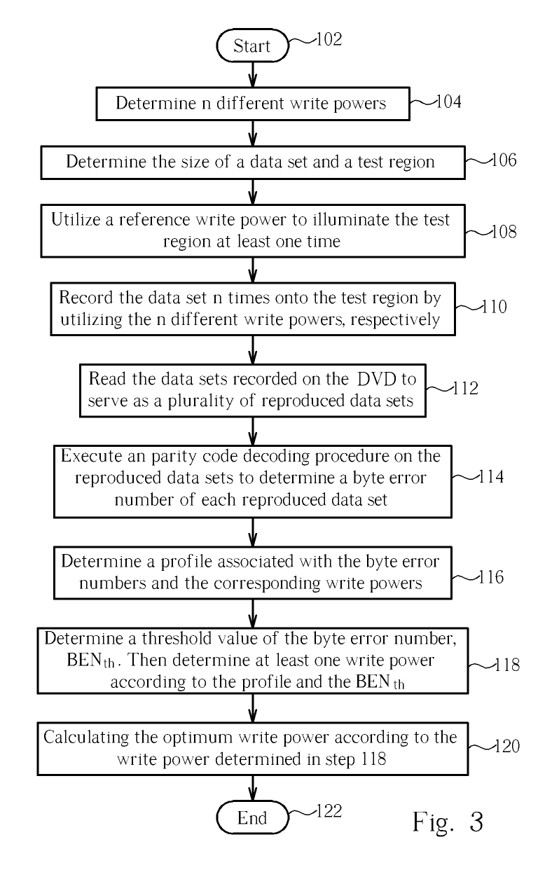

According to the characteristics of the ECC blocks mentioned above, a write power calibrating method applied to an OPC procedure is disclosed in the present invention. Referring to FIG. 3, which is a flow chart of the write power calibrating method applied to the DVD recording device according to an embodiment of the present invention. The write power calibrating method is represented in the following steps:

Step 102: Start.

Step 104: Determine n different write powers.

Step 106: Determine the size of a data set to be m rows of an ECC block and determine a test region corresponding to n*m rows of an ECC block.

Step 108: Utilize a reference write power to illuminate the test region at least one time.

Step 110: Record the data set n times onto the test region by utilizing the n different write powers respectively.

Step 112: Read the data sets recorded on the DVD to serve as a plurality of reproduced data sets.

Step 114: Execute a parity code decoding procedure on the reproduced data sets to decode the parity code of each reproduced data set and detect a byte error number by utilizing the parity code.

Step 116: Determine a profile associated with the byte error numbers and the corresponding write powers.

Step 118: Determine a threshold value of the byte error number, BENₜₕ. Then determine at least one write power according to the profile and the BENₜₕ.

Step 120: Calculate the optimum write power according to the write power determined in step 11 8.

Step 122: End.

In the present embodiment, a reference write power is a default value stored in the DVD recording device and is used to determine n different write powers (step 104). In other embodiments, the reference write power could be obtained by reading the lead-in area of the DVD.

Secondly, the write power calibrating method determines the size of a data set to be m rows of an ECC block (step 106). Hence, the size of the test region for testing write power is n*m row of the ECC block. Next, the write power calibrating method drives the laser to illuminate the test region at least one time (step 108). Please note that since the optical disc utilized by the present embodiment is DVD/RW or DVD-RAM, step 108 is necessary for increasing accuracy. If the optical disc is DVD/R, step 108 is omitted.

In the present embodiment, the write power calibrating method records the data set n times onto the test region by utilizing the n different write powers respectively (step 110). In another embodiment, the write power calibrating method record n data sets by n different powers respectively. Next, the write power calibrating method reads the data sets recorded on the optical disc to serve as a plurality of reproduced data sets (step 112), then a parity code decoding procedure is executed on the reproduced data sets (step 114). In the present embodiment, the parity code PI codes. Since the PI code decoding procedure is executed on each row of the ECC block, the minimum size of a data set is a row of an ECC block. It is obvious that the size of a data set utilized in the present invention is usually smaller than the size of a data set utilized in the related art. Consequently, as the size of the test region is fixed, the present invention is capable of utilizing more write powers to record the data set than the related art. It can therefore be seen that the accuracy of the generated optimum write power increases accordingly.

Please note that the parity code decoding procedure is not limited to the PI code decoding procedure. The write power calibrating method is capable of utilizing a PO code decoding procedure according to a reasonable modification.

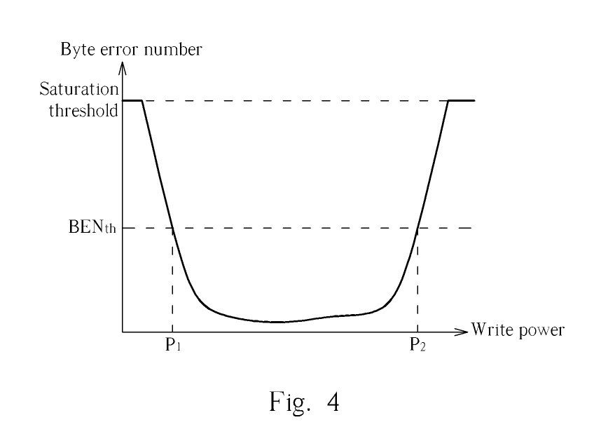

The write power calibrating method determines a profile associated with the byte error numbers and the corresponding write powers (step 11 6). Referring to FIG. 4, which is a schematic diagram of a profile associated with the byte error numbers and the corresponding write powers according to the present embodiment. A threshold value of the byte error number, BENₜₕ, should be pre-defined in the DVD recording system. According to the BENₜₕ value, a first write power P₁ on the profile could be also defined, where the byte error number corresponding to the first write power P₁ is equal to the BENₜₕ. The frist write power P₁ is multiplied by a predetermined gain value to generate the optimum write power. It should be noted that the method of generating the optimum write power according to the first write power P₁ is not limited to that described in the present embodiment. For example, according to another embodiment, the optimum write power can be generated by adding the first write power P₁ to a predetermined offset value. Furthermore, the predetermined gain value and the predetermined offset value can be adjusted according to the type of the DVD. Additionally, the present invention is capable of determining a second write power P₂ on the profile, where the byte error number corresponding to the second write power P₂ is equal to the BENₜₕ too. Then, the optimum write power generates the optimum write power by calculating an average value of the first and second write power Pi and P₂. In summary, other methods for generating the optimum write power according to the profile associated with the byte error numbers and the write powers are also covered by the claimed invention.

During the PI encoding procedure, ten additional bytes are added to each row of an ECC block as a PI code. After decoding these ten PI codes, the system could detect P location-known error and N location-unknown error. The limitation equation between P and N are: (P+2N)<=10. In order to simplify the following description, there will be only a description of the embodiment about the location-unknown error and omit the location-known error. Therefore only five location-unknown error bytes can be detected even if more than 5 location-unknown error bytes exist in a row of an ECC block. As result, if more than 5 location-unknown error bytes exist in a row of an ECC block, the PI decoding procedure assigns a predetermined value, such as 6, to the generated byte error number according to the present embodiment. As shown in FIG. 4, the byte error numbers are clamped by a saturation value. That is, if the size of the data sets is equal to two rows of an ECC block, the saturation threshold is twelve. Therefore, the write power calibrating method has an advantage of defect clamping due to the characteristic of the present invention.

In the related art, when a defect exists in the test region, a series of error bytes occur. The burst error, such as 1 83 error bytes, dramatically influences the profile shown in FIG. 4. For alleviating the influence of the defect, the size of the data sets utilized by the related art write power calibrating apparatus must be much greater than a defect. As result, not only the advantage of defect clamping is reached according to the present invention, but the size of the data set required also decreases.

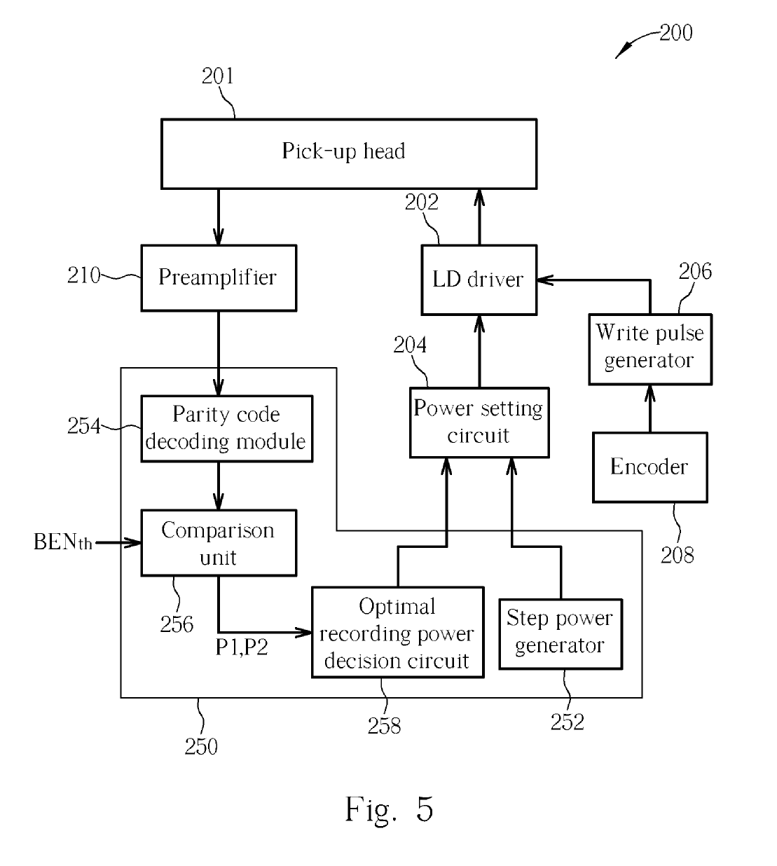

The hardware architecture for realizing the write power calibrating method mentioned above is introduced in the following paragraphs. Please refer to FIG. 5. FIG. 5 is a functional block diagram of a write power calibrating apparatus 250 applied in a DVD drive 200 according to a present embodiment of the present invention. As shown in FIG. 5, the DVD drive 200 comprises a pick-up head 201, a laser diode driver 202, a power setting circuit 204, a write pulse generator 206, an encoder 208, a preamplifier 210, and the write power calibrating apparatus 250. Please note that the operation of the pick-up head 201, the laser diode driver 202, the power setting circuit 204, the write pulse generator 206, the encoder 208, and the preamplifier 210 are all well known by those skilled in the art, so a detailed description of the components mentioned above is omitted for the sake of brevity.

The write power calibrating apparatus 250 comprises a step power generator 252, a parity code decoding module 254, a comparison unit 256, and an optimum power generating module 258. The step power generator 252 is utilized to generate the write powers in order to test the optimum write power of a digital versatile disc. The parity code decoding module 254 receives the reproduced parity code, and determines the byte error numbers detected by the parity code. Please note that according to the embodiment the parity code decoding module 254 is a decoder capable of detecting and correcting the error bytes through utilizing the PI code or PO code. As a result, no extra devices are needed according to the present embodiment. In other words, the write power calibrating apparatus 250 would not increase the cost of a DVD drive obviously. In the present embodiment, the comparison unit 256 receives a plurality of byte error numbers detected by the parity code of the data sets, and selects the first write power P₁ and/or the second write power P₂ corresponding to the BENₜₕ. Finally, the optimum power generating module 258 calculates the optimum write power according to the first write power P₁ and/or the second write power P₂.

Please note that, if there does not any write power used to record the data sets corresponding to the BENₜₕ, in another embodiment, the comparison unit 256 could take two byte error numbers which are close to the BENₜₕ to get the corresponding two write powers P₃, P₄. Then, the comparison unit 256 could determine the first write power P₁ or the second write power P₂ according to an interpolation of the two write powers P₃, P₄. Then, the optimum power generating module 258 calculates the optimum write power according to the first write power P₁ or the second write power P₂.

Compared with the related art, the write power calibrating apparatus and the related method have the advantage of defect clamping. Additionally, the size of the data sets utilized by the write power calibrating apparatus is smaller than the size of the data sets utilized by the related art apparatus. As a result, the optimum write power is generated with fewer system resources according to the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A write power calibrating method for determining an optimum write power used for recording data onto a digital versatile disc (DVD), the write power calibrating method comprising:
recording a plurality of first data sets onto the digital versatile disc by utilizing a plurality of different write powers respectively;
executing an parity code decoding procedure on a plurality of second data sets read from the digital versatile disc to determine a plurality of byte error numbers detected by utilizing a parity code of each of the second data sets, the second data sets corresponding to the first data sets written onto the digital versatile disc; and
determining the optimum write power according to the byte error numbers of the second data sets.

2. The write power calibrating method of claim 1, wherein each of the first data sets corresponds to at least one row of an error correction coed (ECC) block, and the parity code decoding procedure is applied to decode the Parity Inner (PI) codes of the second data sets for determining the byte error numbers of the second data sets.

3. The write power calibrating method of claim 1, wherein each of the first data sets corresponds to at least one column of an ECC block, and the parity code decoding procedure is applied to decode the Parity Outer (PO) codes of the second data sets for determining the byte error numbers of the second data sets.

4. The write power calibrating method of claim 1, wherein the step of determining the optimum write power further comprises:
determining a profile associated with the byte error numbers of the second data sets and the write powers of the first data sets;
determining a threshold value of byte error number;
determining a first write power corresponding to a byte error number close to the threshold value; and
calculating the optimum write power according to the first write power.

5. The write power calibrating method of claim 4, wherein the step of calculating the optimum write power further comprises:
generating the optimum write power by multiplying the first write power by a predetermined gain value.

6. The write power calibrating method of claim 4, wherein the step of calculating the optimum write power further comprises:
generating the optimum write power by adding a predetermined offset value to the first write power.

7. The write power calibrating method of claim 4, wherein the step of determining the optimum write power further comprises:
determining a second write power corresponding a byte error number close to the threshold value; and
the step of calculating the optimum write power further comprises:
generating the optimum write power by calculating an average value of the second write power and the first write power.

8. A write power calibrating apparatus for determining an optimum write power used for recording data onto a digital versatile disc (DVD), the write power calibrating apparatus comprising:
a step power generator for generating a plurality of write powers used for driving a laser to record a plurality of first data sets onto the digital versatile disc according to the plurality of write powers respectively;
an parity code decoding module for decoding a parity code of each of the second data sets to determine a plurality of byte error numbers of a plurality of second data sets, the second data sets corresponding to the first data sets written onto the digital versatile disc; and
an optimum power generating module for generating the optimum write power according to the byte error numbers of the second data sets.

9. The write power calibrating apparatus of claim 8, wherein each of the first data sets corresponds to at least one row of an ECC block, and the parity code decoding module decodes the Parity Inner (PI) codes of the second data sets for determining the byte error numbers of the second data sets.

10. The write power calibrating apparatus of claim 8, wherein each of the first data sets corresponds to at least one column of an ECC block, and the parity code decoding module decodes the Parity Outer (PO) codes of the second data sets for determining the byte error numbers of the second data sets.

11. The write power calibrating apparatus of claim 8, wherein the optimum write power generating module determines a profile associated with the byte error numbers of the second data sets and the write powers of the first data sets, determines a threshold value of byte error number, determines a first write power corresponding to a byte error number close to the threshold value, and calculates the optimum power according to the first write power.

12. The write power calibrating apparatus of claim 11, wherein the optimum write power generating module generates the optimum write power by multiplying the first write power by a predetermined gain value.

13. The write power calibrating apparatus of claim 11, wherein the optimum write power generating module generates the optimum write power by adding a predetermined offset value to the first write power.

14. The write power calibrating apparatus of claim 1 1, wherein the optimum write power generating module further determines a second write power corresponding to a byte error number close to the threshold value according to the profile, and generates the optimum write power by calculating an average value of the second write power and the first write power.
